(19) United States
(12) Patent Application Publication
(10) Pub. No.: US 2010/0191571 A1
(43) Pub. Date: Jul. 29, 2010

(54) DYNAMIC ADVERTISEMENT

(75) Inventors: John Lewis, Lawrenceville, GA (US); Justin McNamara, Atlanta, GA (US); Fulvio Arturo Cenciarelli, Suwanee, GA (US); Jeffrey Mikan, Atlanta, GA (US)

Correspondence Address: AT&T Legal Department - WW, Patent Docketing Room 2A-207, One AT&T Way, Bedminster, NJ, 07921, US

(73) Assignee: AT&T MOBILITY II LLC, Atlanta, GS (US)

(21) Appl. No.: 12/358,767

(22) Filed: Jan. 23, 2009

(51) Int. Cl. G06Q 30/00; G06Q 10/00; H04W 4/12

(52) U.S. Cl. 705/10; 455/466; 705/14.4

(57) ABSTRACT

Provided are mobile communications devices comprising a user interface portion configured to provide an advertisement via the device, wherein provision of the advertisement is correlated to an occurrence of an event associated with a use of the device. Also provided are methods for providing an advertisement through a user interface portion of a mobile communications device, as well as network entities comprising software that is configured to provide an advertisement through a user interface portion of a mobile communications device in communication with the network entity. The provision of advertisements in accordance with the present disclosure comprises a “dynamic” process whereby advertisements are correlated to an occurrence of an event associated with a use of the mobile communications device to which the advertisement is provided.

### TECHNICAL FIELD

The technical field relates generally to providing capabilities on a device, such as a processor or mobile device. More specifically, technical field pertains to methods and devices for the provision of advertisement capabilities on devices, especially mobile devices such as cellular telephones and GPS modules.

### BACKGROUND

The use of mobile devices such as cellular telephones, global positioning system (GPS) devices, personal digital assistants (PDAs), laptops, and the like is becoming more widespread as the cost and size of such devices decreases even as the functionality and mobility increases. Today, internet “pop-up” advertisements or static telephone advertisement displays remain the primary ways to deliver advertising content to users of mobile devices. Such methods of advertising are relatively limited and do not make full use of the mobility, functionality, and accessibility of mobile devices in order to deliver advertising content to users.

### SUMMARY

In one aspect, the present invention provides communications devices comprising a user interface portion configured to provide an advertisement via the device, wherein provision of the advertisement is correlated to an occurrence of an event associated with a use of the device, the event comprising at least one of the receipt by the device of an incoming call, the initiation by the device of an outgoing call from the device, the receipt by the device of a text based message, the composition by a user of the device of an outgoing text message, the transmission by the device of an outgoing text message, or the receipt by the device of a location based service. In certain embodiments, the advertisement is supplied by an entity other than any of a sender of the incoming call, a recipient of the outgoing call from the device, a sender of the text based message, or a recipient of the outgoing text message.

In another aspect, there are disclosed methods comprising providing an advertisement through a user interface portion of a mobile communications device, wherein provision of the advertisement is correlated to an occurrence of an event associated with a use of the device, the event comprising at least one of the receipt by the device of an incoming call, the initiation by the device of an outgoing call from the device, the receipt by the device of a text based message, the composition by a user of the device of an outgoing text message, the transmission by the device of an outgoing text message, or the receipt by the device of a location based service. In certain embodiments, the advertisement is supplied by an entity other than any of a sender of the incoming call, a recipient of the outgoing call from the device, a sender of the text based message, or a recipient of the outgoing text message.

Also provided are network entities comprising software that is configured to provide an advertisement through a user interface portion of a mobile communications device in communication with said network entity, wherein provision of the advertisement is correlated to an occurrence of an event associated with a use of the device, the event comprising at least one of the receipt by the device of an incoming call, the initiation by the device of an outgoing call from the device, the receipt by the device of a text based message, the composition by a user of the device of an outgoing text message, the transmission by the device of an outgoing text message, or the receipt by the device of a location based service. In certain embodiments, the advertisement is supplied by an entity other than any of a sender of the incoming call, a recipient of the outgoing call from the device, a sender of the text based message, or a recipient of the outgoing text message.

### BRIEF DESCRIPTION OF THE DRAWINGS

FIG. 1 provides a depiction of an exemplary mobile communications device that comprises a user interface portion configured to provide an advertisement via the device.

FIG. 2 provides a depiction of a second exemplary mobile communications device that comprises a user interface portion configured to provide an advertisement via the device.

FIG. 3 depicts yet another mobile communications device that has a user interface portion that is configured to provide an advertisement via the device.

FIG. 4 is a flow diagram of an exemplary process whereby an advertisement is provided through a user interface portion of a mobile communications device.

FIG. 5 depicts an overall block diagram of an exemplary packet-based mobile cellular network environment, such as a GPRS network, with which there may be used a device that is configured to provide an advertisement through a user interface portion.

FIG. 6 illustrates an exemplary architecture of a typical GPRS network with which there may be used a device that is configured to provide an advertisement through a user interface portion.

FIG. 7 illustrates an exemplary block diagram view of a GSM/GPRS/IP multimedia network architecture within which there may be used a device that is configured to provide an advertisement through a user interface portion.

### DETAILED DESCRIPTION OF ILLUSTRATIVE EMBODIMENTS

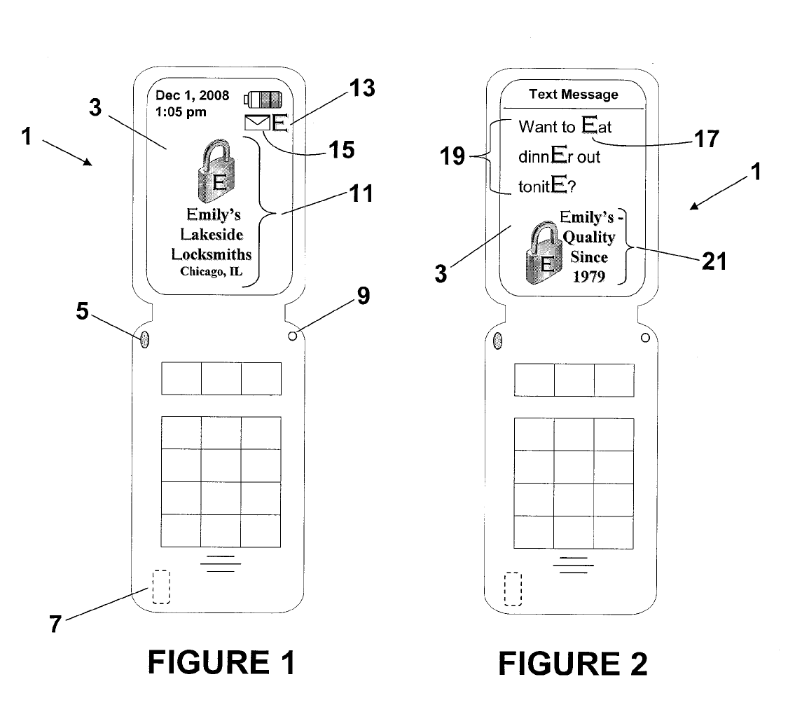

FIGS. 1 and 2 each provide a depiction of an exemplary mobile communications device 1 that comprises a user interface portion configured to provide an advertisement via the device. The device 1 can comprise any appropriate device such as, for example, a cellular telephone, a global positioning system (GPS) unit, a personal digital assistant (PDA), pager, and the like. It is emphasized that the depiction provided in FIGS. 1 and 2 together represent an example intended to illustrate the concept of a device having a user interface portion configured to provide an advertisement via the device 1 and is not intended to imply a specific implementation or architecture. The user interface may be a viewscreen 3, a speaker 5, an internal vibration mechanism 7 (shown as internal component within device 1), a scent-releasing module 9, or any other component, element, or mechanism; as used herein, the “user interface” may be any component, element, or mechanism that is capable of producing an outcome that can be perceived by a user of the mobile communications device.

The user interface portion of the device 1 is configured to provide an advertisement. The advertisement may be provided by the user interface as at least one of a visual cue on the viewscreen 3, as a ringtone or other sound or series of sounds through a speaker 5 or other mechanism capable of transmitting sound, as a vibration, for example, as a recognizably patterned vibration, through internal vibration mechanism 7, as a scent through scent-releasing module 9, or by any other means that can be perceived by a user of device 1. It will be appreciated that scent-releasing modules have been developed for the delivery of scents by an electronic device that employs a chemical bank and a mixing algorithm in order to produce any of a number of desired scents. Device 1 may include the components necessary for producing such “digital scents” as or in conjunction with an advertisement. When the advertisement is provided as a visual cue on viewscreen 3, the advertisement may be in the form of, for example, at least one of a customized text font, a “wallpaper” background, a background for a text based message, a weblink, or an advertising icon.

In certain embodiments, the advertisement is supplied by an entity other than any of a sender of the incoming call, a recipient of the outgoing call from the device, a sender of the text based message, or a recipient of the outgoing text message. For example, where the event is the receipt by the device of an incoming call, the advertisement may be provided by an entity other than the entity from which the incoming call originates. Where the event is the initiation of an outgoing call from the device, the advertisement may be provided by an entity other than the intended recipient of the outgoing call. Where the event is the receipt by the device of a text based message, the advertisement may be provided by an entity other than the entity from which the incoming text message originates. Where the event is the transmission of the device of an outgoing text message, the advertisement may be provided by an entity other than the intended recipient of the text message.

In some embodiments, the advertisement is supplied either directly or indirectly by the service provider that provides the communications service to the device. “Supplying” the advertisement refers to the transmission of the advertisement to the device. Advertisements may refer to goods and/or services offered by the service provider, goods and/or services offered by an advertiser other than the service provider, or both. Where an advertisement refers to goods and/or services offered by an advertiser other than the service provider, the service provider may be an intermediary through which the advertisement is supplied to the user of the device. For example, an advertiser may provide advertising content to the service provider, which may optionally store the advertisement prior to supplying the advertising content to the user's device in one or more of the forms described supra. Those skilled in the art will readily appreciate the means by which advertising content may be stored and/or supplied to a user's device as, for example, at least one of a visual cue on the viewscreen 3, a ringtone or other sound or series of sounds, a vibration, a scent, or by any other means that can be perceived by a user of device 1.

The temporal duration of the advertisement may depend on the type of advertisement that is provided. For example, if the advertisement is provided as a ringtone or other series of sounds, the advertisement could have a total duration of about 1 minute or less, 30 seconds or less, 20 seconds or less, 10 seconds or less, 5 seconds or less, or until the user answers the incoming call that is brought to the user's attention through the ringtone. If the advertisement is provided as a visual cue on the viewscreen 3, then the duration of the advertisement could have a total duration of 3 hours or less, 2 hours or less, 1 hour or less, 30 minutes or less, 15 minutes or less, 10 minutes or less, 5 minutes or less, 1 minute or less, 30 seconds or less, 10 seconds or less, or until the user performs some act in response to the advertisement, such as selecting a weblink that is displayed as part of or as the entirety of the advertisement. In general, the temporal duration of the advertisement may be selected in accordance with what is known or may be learned regarding user preferences, duration required for maximum efficacy of the advertisement, or other factors with which the skilled artisan will readily appreciate.

In FIG. 1, device 1 provides a first advertisement type 11 as a wallpaper background. Advertisements that are provided as wallpaper backgrounds may consist of one or more of static or animated images, text, or weblinks. Device 1 also provides a second advertisement type 13 as an advertising icon. In the example depicted in FIG. 1, the stylized “E” is an icon associated with the advertiser; in this instance, the advertiser is “Emily's Lakeside Locksmiths”. The advertising icon can be nonfunctional or can be selectable by a user of device 1 in order to access an additional function on device 1, such as a received text based message, a received voicemail message, or a webpage depicting a commercial offer or a reward. The advertising icon can be accompanied by a symbolic representation of the additional function that can be accessed; for example, in FIG. 1, second advertisement type 13, an advertising icon, is accompanied by a letter symbol 15, which indicates that selection of the second advertisement type 13 by the user will access a received text based message.

In FIG. 2, device 1 provides a third advertisement type 17 as a customized text font within a text message 19. The customized text font may make use of a text font that is familiarly associated with a particular advertiser; in this instance, the advertiser is “Emily's Lakeside Locksmiths”. The customized text font may automatically appear within an outgoing text message composed by a user of device 1 (for example, as the user types in the text message, the customized text font automatically appears), within a text message that is received by device 1, or within a text message that is sent by a user of device 1 and received by a third-party device. In FIG. 1B device 1 also provides a fourth advertisement type 21 as a background of text message 19. Advertisements that are provided as text message backgrounds may consist of one or more of static or animated images, text, or weblinks.

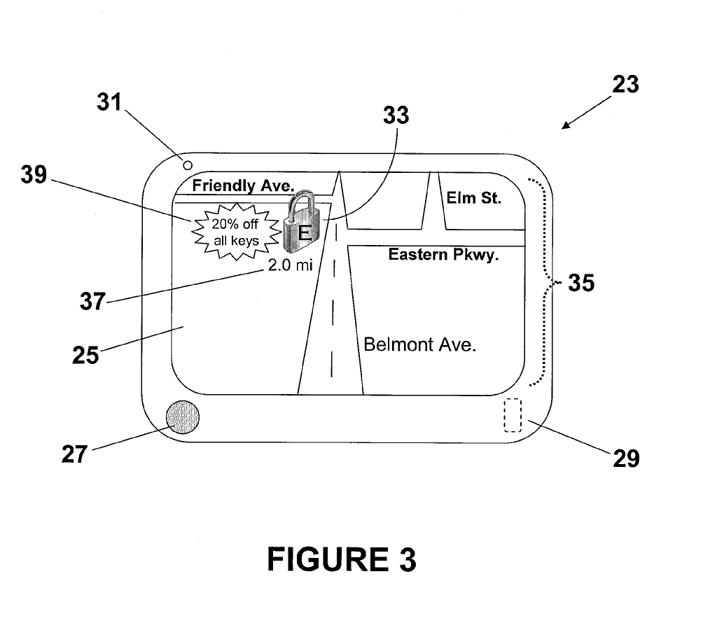

FIG. 3 depicts another mobile communications device that has a user interface portion that is configured to provide an advertisement via the device, wherein the provision of the advertisement is correlated to an occurrence of an event that is associated with a use of the device. Device 23 is a global positioning system (GPS) unit. As in FIGS. 1 and 2, the user interface of device 23 may be a viewscreen 25, a speaker 27, an internal vibration mechanism 29 (shown as internal component within device 23), a scent-releasing module 31, or any other component, element or mechanism.

The user interface portion of the device 23 is configured to provide an advertisement. The advertisement may be provided by the user interface as at least one of a visual cue on the viewscreen 25, as an audible tone or other sound or series of sounds through a speaker 27 or other mechanism capable of transmitting sound, as a vibration, for example, as a recognizably patterned vibration, through internal vibration mechanism 29, as a scent through scent-releasing module 31, or by any other means that can be perceived by a user of device 1. When the advertisement is provided as a visual cue on viewscreen 25, the advertisement may be in the form of at least one of a customized text font, a “wallpaper” background, a weblink, or an advertising icon.

Device 23 provides a first advertisement type 33 as an advertising icon on a map 35 displayed on viewscreen 25. In the example depicted in FIG. 3, the “padlock” image and the stylized “E” together form an icon associated with the advertiser; in this instance, the advertiser is “Emily's Lakeside Locksmiths”. The advertising icon can be nonfunctional or can be selectable by a user of device 33 in order to access an additional function on device 33, such as a received commercial message or an additional page view depicting a commercial offer or a reward. First advertisement type 33 designates where the physical location of the advertiser may be found relative to the other elements on the map 35; in FIG. 3, the location of first advertisement type 33 indicates that the physical location of the advertiser is on the corner of “Belmont Ave.” and “Friendly Ave.” As a part of first advertisement type 33, map 35 may also provide the distance 37 from the user's location to the physical location of the advertiser, a commercial offer 39 presently available through patronage of the advertiser at the depicted location, or both.

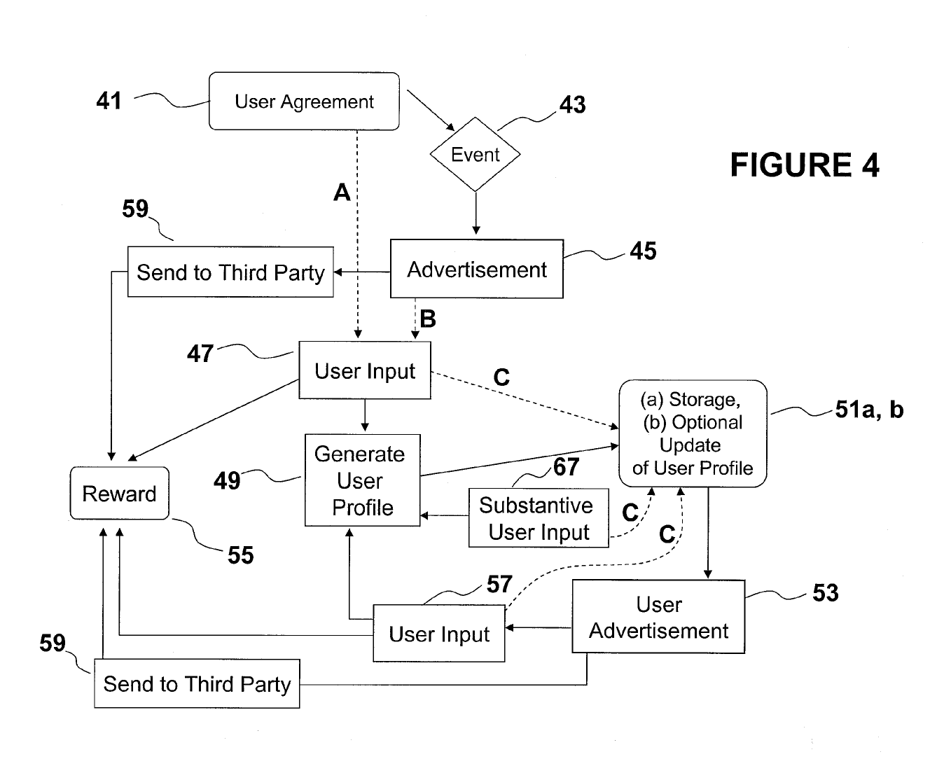

FIG. 4 is a flow diagram of an exemplary process whereby an advertisement is provided through a user interface portion of a mobile communications device. The process may be initiated when a user agrees 41 to receive advertisements on a mobile communications device in user's possession. The user agreement may include a subscription to a service for a fixed period of time whereby the user agrees to receive advertisements in one or more forms in exchange for valuable consideration. For example, for agreeing to receive advertisements, the user may receive a discount on mobile communications services to the device, or a reward (such as a gift certificate that can be used to obtain certain goods or services) that is associated with a particular advertiser, with the user's mobile service provider, or another party. Alternatively, as described more fully below, rewards may accrue upon receipt of an advertisement, whenever the user provides some form of input through the device, such as response to an advertisement or the provision of user information.

An advertisement 45 is provided through a user interface portion of the user's device in correlation to an occurrence of an event 43 associated with a use of the device. Thus, the provision of advertisements in accordance with the present disclosure is “dynamic”, i.e., does not constitute a permanent incorporation of an advertisement that does not change in appearance and/or content into some feature of the user's device. Event 43 may comprise at least one of the receipt by the device of an incoming call, the initiation by the device of an outgoing call from the device, the receipt by the device of a text based message, the composition by a user of the device of an outgoing text message, the transmission by the device of an outgoing text message, or the receipt by the device of a location based service. The receipt and transmission of “calls” are typically associated with mobile cellular telephones. Text based messages may be received and/or sent by cellular telephones, PDAs, pagers, and other devices. Location base services are received by cellular telephones, PDAs, pagers, and GPS modules. Any device capable of rendering or being subjected to an “event” as described herein is contemplated as being embraced by the scope of the present disclosure.

For example, the device may be a cellular telephone and the event 43 may be the receipt by the device of an incoming call. The receipt of the incoming call may result in the provision of an advertisement 45 in the form of a ringtone. The ringtone may be a tune, a spoken message, or any other sound or series of sounds associated with an advertiser. Alternatively or additionally, the receipt of the incoming call may result in the provision of an advertisement 45 in the form of at least one of an advertising message, weblink, or advertising icon on the telephone's viewscreen. The advertising message may be, for example, a slogan or a commercial offer. The weblink may offer the user an opportunity to visit a webpage that includes product information, a commercial offer, information regarding a reward, or any other commercial message. If an advertising icon is displayed, the icon may be an animated or static image that is merely meant to be viewed by the user, or may itself be “selectable” in the manner of a weblink in order to allow the user to access a webpage or some other additional information. In the above described manner or in other comparable ways, the provision of an advertisement 45 may be followed by some form of user input 47 regarding the advertisement 45.

Thus, the user interface portion of the device may be configured to accept a user input 47 regarding the advertisement. As used herein, acceptance of a user input regarding the advertisement may refer to a user response to an advertisement (FIG. 4, line B), such as the election by the user to accept an offer to visit a webpage or view a commercial offer or other message; the acceptance of a user input regarding the advertisement may also refer to information provided by a user that is not necessarily in response to a specific advertisement but that reflects information about a user, such as gender, age, income range, hobbies, spending profile, and other information (collectively, “user preference information”) that reflects the user's individual desires, tastes, habits, and spending choices. The user preference information may voluntarily be provided by the user upon entry into the user agreement 41, before any advertisement has been provided to the user's device (FIG. 4, line A). Alternatively, the user preference information may be provided by the user at any time after the provision of the first advertisement (FIG. 4, line B).

Accordingly, user input 47, 57 may comprise a user response to an advertisement (line B); may comprise the provision of user preference information by the user before any advertisement has been provided (line A); or may comprise the provision of user preference information by the user at any time following the first provision of an advertisement pursuant to the user agreement 41. User input may also comprise substantive information 67 derived from certain uses of the communications device. In one embodiment, the device may be equipped to conduct voice recognition of certain keywords spoken during a telephone conversation between the user and a third party, or to conduct text recognition of certain keywords in a user's text message. The user may speak certain words relating to a good or service provided by a particular advertiser, or may type such words into a text message, thereby suggesting that the user may be interested in receiving an advertisement from that advertiser. The device may be configured to detect such words, recognize them, and allow them to be correlated certain advertisers. For example, the user may speak or write words like “security”, “locks”, “keys”, which relate to an advertiser like “Emily's Lakeside Locksmiths”.

User input 47, 57, 67 may be used to generate a user profile 49. The user profile reflects one or more of a user's response to an advertisement 47, 57 user preference information as input by the user 47, or the use (e.g., by voice or text) of certain product- or service-related keywords 67. The user profile can be used to generate an advertisement protocol, i.e., a predetermined set of advertisements of a particular type, from a particular type of vendor(s), or that otherwise reflect the user's individual characteristics and preferences. In other words, user profile 49 can be used to generate and provide an advertising curriculum that is custom tailored to the user's needs and is therefore more likely to engender user interest. Following the generation 49 and storage 51a of a user profile, a so-called “user advertisement” 53, i.e., an advertisement that comports with the user's personal interests, may be provided to the user's device. The user profile may be stored 51a by the device or by a network element in communication with the device. Optionally, the user profile may be updated 51b and re-stored, in response to additional user input (FIG. 4, all lines labeled C); in this way, the user profile will reflect the user's preferences, even over time and as the user's interests change or are supplemented.

The communications device may further comprise a processing portion that is configured to create and optionally update a user profile that is based on the user input. The device may also comprise a memory portion that is configured to store the user profile and optionally receive updates of the user profile from the processing portion. Alternatively, the device may communicate with a network element in order to create and optionally provide updates to a user profile that is based on the user input, and the created user profile may be updated via communication between the device and the network element. In accordance with the present disclosure, the device and the network element in communication with the device may together perform any combination of the tasks of generation, storing, and updating of a user profile.

The user profile may also reflect user input 57 that is in response to a user advertisement 53. In this manner the user profile may be even further refined.

The user interface of the device may also be configured such that the user receives a reward 55 in acknowledgement of the provision of user input 47, 57. Reward 55 may be a discount on an advertiser's goods or services, a certain number of “points” that can be accumulated and exchanged for various desirable items, or any other item, service, or offer of value. The reward may be provided in the form of a coupon, weblink, or other information on the device's viewscreen, in the form of acoustic instructions as to how to claim the reward via the device's speaker, or by any other means that may be perceived by the user. The availability of a reward 55 in exchange for the provision of user input 47, 57 can induce the user of the device to pay closer attention to any received advertisement or to provide additional user input 47, 57 inasmuch as the user might not otherwise be so inclined.

In accordance with the present disclosure, the user of the device may also receive a reward when the user sends to a third party 59 an advertisement 45 or a user advertisement 53, such that the third party has the opportunity to perceive the advertisement 45, 53 and thereby benefit the advertiser. For example, if the user sends the third party a text message in which a customized text font or an advertising icon is incorporated, then the user may receive a reward in recognition of the user's having exposed the third party to the advertisement in the text message.

The present disclosure is also provides network entities comprising software that is configured to provide an advertisement through a user interface portion of a mobile communications device in communication with said network entity.

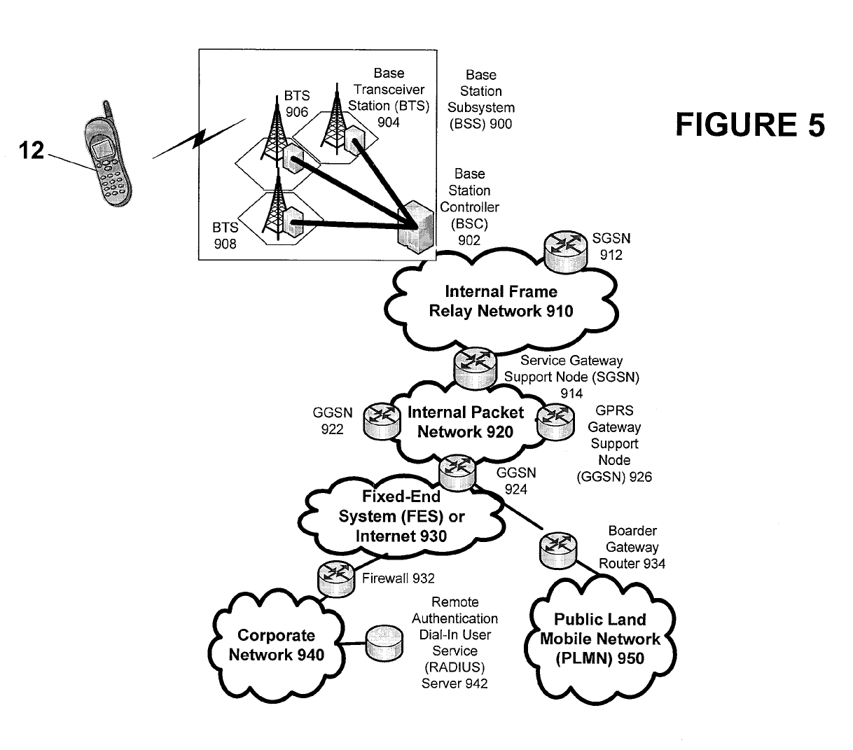

FIG. 5 depicts an overall block diagram of an exemplary packet-based mobile cellular network environment, such as a GPRS network, with which there may be used a device 12 that is configured to provide an advertisement through a user interface portion. In such an environment, there are a plurality of Base Station Subsystems (“BSS”) 900 (only one is shown), each of which comprises a Base Station Controller (“BSC”) 902 serving a plurality of Base Transceiver Stations (“BTS”) such as BTSs 904, 906, and 908. As depicted in FIG. 5, the device 12 is in communications with BSS 900. BTSs 904, 906, 908, etc. are the access points where users of packet-based mobile devices become connected to the wireless network. In exemplary fashion, the packet traffic originating from user devices (e.g., device 12) is transported via an over-the-air interface to a BTS 908, and from the BTS 908 to the BSC 902. Base station subsystems, such as BSS 900, are a part of internal frame relay network 910 that can include Service GPRS Support Nodes (“SGSN”) such as SGSN 912 and 914. Each SGSN is connected to an internal packet network 920 through which a SGSN 912, 914, etc. can route data packets to and from a plurality of gateway GPRS support nodes (GGSN) 922, 924, 926, etc. As illustrated, SGSN 914 and GGSNs 922, 924, and 926 are part of internal packet network 920. Gateway GPRS serving nodes 922, 924 and 926 mainly provide an interface to external Internet Protocol (“IP”) networks such as Public Land Mobile Network (“PLMN”) 950, corporate intranets 940, or Fixed-End System (“FES”) or the public Internet 930. As illustrated, subscriber corporate network 940 may be connected to GGSN 924 via firewall 932; and PLMN 950 is connected to GGSN 924 via boarder gateway router 934. The Remote Authentication Dial-In User Service (“RADIUS”) server 942 may be used for caller authentication when a user of a mobile cellular device calls corporate network 940.

Generally, there can be four different cell sizes in a GSM network, referred to as macro, micro, pico, and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. On the other hand, umbrella cells are used to cover shadowed regions of smaller cells and fill in gaps in coverage between those cells.

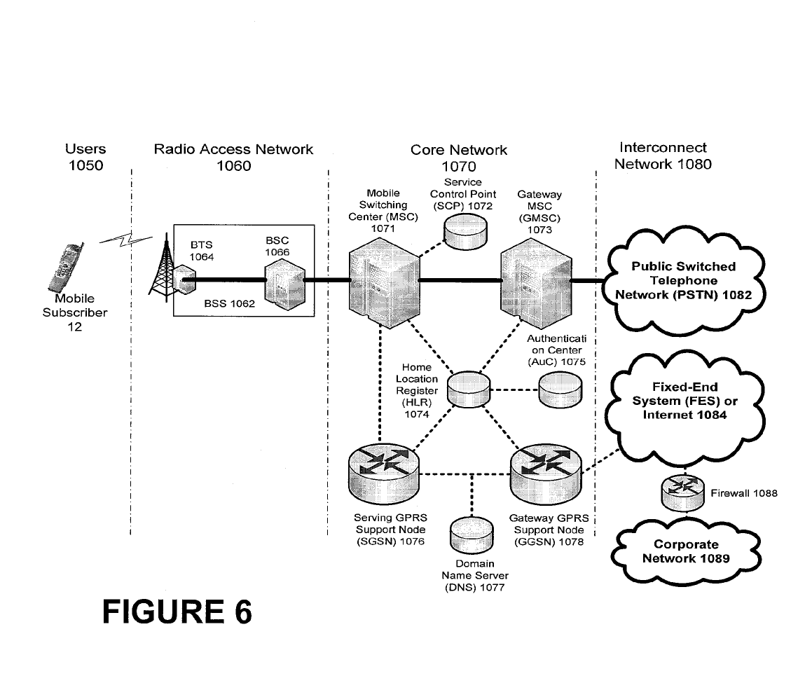

FIG. 6 illustrates an architecture of a typical GPRS network in which the device 12 that is configured to provide an advertisement through a user interface portion can be utilized. The architecture depicted in FIG. 6 is segmented into four groups: users 1050, radio access network 1060, core network 1070, and interconnect network 1080. Users 1050 comprise a plurality of end users. Note, device 12 is referred to as a mobile subscriber in the description of network shown in FIG. 6. In an example embodiment, the device depicted as mobile subscriber 12 comprises a mobile device. Radio access network 1060 comprises a plurality of base station subsystems such as BSSs 1062, which include BTSs 1064 and BSCs 1066. Core network 1070 comprises a host of various network elements. As illustrated here, core network 1070 may comprise Mobile Switching Center (“MSC”) 1071, Service Control Point (“SCP”) 1072, gateway MSC 1073, SGSN 1076, Home Location Register (“HLR”) 1074, Authentication Center (“AuC”) 1075, Domain Name Server (“DNS”) 1077, and GGSN 1078. Interconnect network 1080 also comprises a host of various networks and other network elements. As illustrated in FIG. 10, interconnect network 1080 comprises Public Switched Telephone Network (“PSTN”) 1082, Fixed-End System (“FES”) or Internet 1084, firewall 1088, and Corporate Network 1089.

A mobile switching center can be connected to a large number of base station controllers. At MSC 1071, for instance, depending on the type of traffic, the traffic may be separated in that voice may be sent to Public Switched Telephone Network (“PSTN”) 1082 through Gateway MSC (“GMSC”) 1073, and/or data may be sent to SGSN 1076, which then sends the data traffic to GGSN 1078 for further forwarding.

When MSC 1071 receives call traffic, for example, from BSC 1066, it sends a query to a database hosted by SCP 1072. The SCP 1072 processes the request and issues a response to MSC 1071 so that it may continue call processing as appropriate.

The HLR 1074 is a centralized database for users to register to the GPRS network. HLR 1074 stores static information about the subscribers such as the International Mobile Subscriber Identity (“IMSI”), subscribed services, and a key for authenticating the subscriber. HLR 1074 also stores dynamic subscriber information such as the current location of the mobile subscriber. Associated with HLR 1074 is AuC 1075. AuC 1075 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 6, when mobile subscriber 12 initiates the attach process by turning on the network capabilities of the mobile device, an attach request is sent by mobile subscriber 12 to SGSN 1076. The SGSN 1076 queries another SGSN, to which mobile subscriber 12 was attached before, for the identity of mobile subscriber 12. Upon receiving the identity of mobile subscriber 12 from the other SGSN, SGSN 1076 requests more information from mobile subscriber 12. This information is used to authenticate mobile subscriber 12 to SGSN 1076 by HLR 1074. Once verified, SGSN 1076 sends a location update to HLR 1074 indicating the change of location to a new SGSN, in this case SGSN 1076. HLR 1074 notifies the old SGSN, to which mobile subscriber 12 was attached before, to cancel the location process for mobile subscriber 12. HLR 1074 then notifies SGSN 1076 that the location update has been performed. At this time, SGSN 1076 sends an Attach Accept message to mobile subscriber 12, which in turn sends an Attach Complete message to SGSN 1076.

After attaching itself with the network, mobile subscriber 12 then goes through the authentication process. In the authentication process, SGSN 1076 sends the authentication information to HLR 1074, which sends information back to SGSN 1076 based on the user profile that was part of the user's initial setup. The SGSN 1076 then sends a request for authentication and ciphering to mobile subscriber 12. The mobile subscriber 12 uses an algorithm to send the user identification (ID) and password to SGSN 1076. The SGSN 1076 uses the same algorithm and compares the result. If a match occurs, SGSN 1076 authenticates mobile subscriber 12.

Next, the mobile subscriber 12 establishes a user session with the destination network, corporate network 1089, by going through a Packet Data Protocol (“PDP”) activation process. Briefly, in the process, mobile subscriber 12 requests access to the Access Point Name (“APN”), for example, UPS.com, and SGSN 1076 receives the activation request from mobile subscriber 12. SGSN 1076 then initiates a Domain Name Service (“DNS”) query to learn which GGSN node has access to the UPS.com APN. The DNS query is sent to the DNS server within the core network 1070, such as DNS 1077, which is provisioned to map to one or more GGSN nodes in the core network 1070. Based on the APN, the mapped GGSN 1078 can access the requested corporate network 1089. The SGSN 1076 then sends to GGSN 1078 a Create Packet Data Protocol (“PDP”) Context Request message that contains necessary information. The GGSN 1078 sends a Create PDP Context Response message to SGSN 1076, which then sends an Activate PDP Context Accept message to mobile subscriber 12.

Once activated, data packets of the call made by mobile subscriber 12 can then go through radio access network 1060, core network 1070, and interconnect network 1080, in a particular fixed-end system or Internet 1084 and firewall 1088, to reach corporate network 1089.

Thus, network elements that can invoke the functionality of a device configured to accommodate a plurality of personas/profiles can include but are not limited to Gateway GPRS Support Node tables, Fixed End System router tables, firewall systems, VPN tunnels, and any number of other network elements as required by the particular digital network.

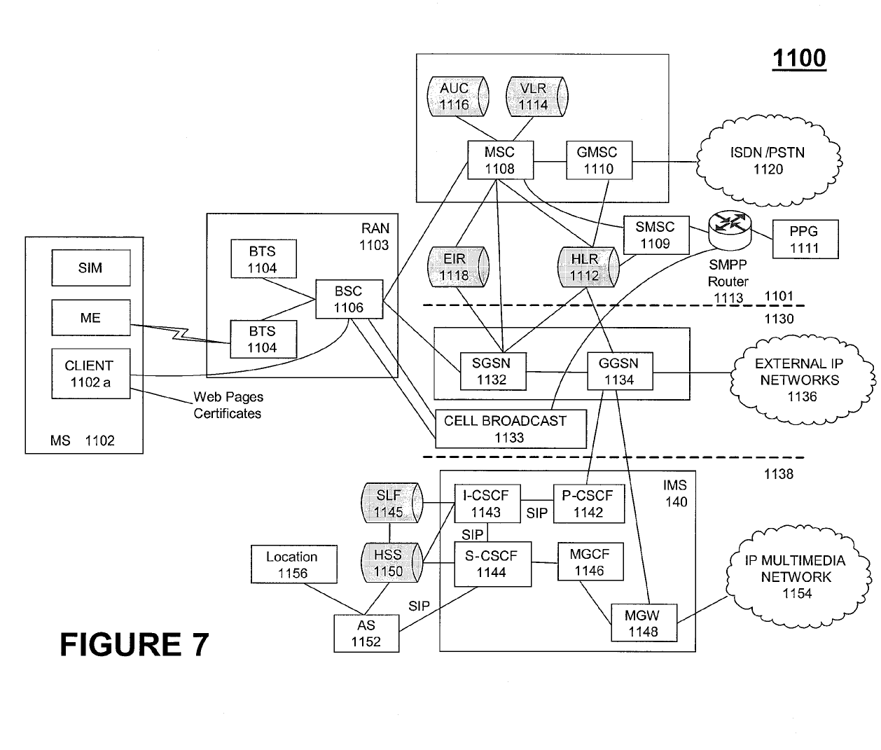

FIG. 7 illustrates an exemplary block diagram view of a GSM/GPRS/IP multimedia network architecture 1100 within which a device that is configured to provide an advertisement through a user interface portion can be utilized. As illustrated, architecture 1100 of FIG. 6 includes a GSM core network 1101, a GPRS network 1130 and an IP multimedia network 1138. The GSM core network 1101 includes a Mobile Station (MS) 1102, at least one Base Transceiver Station (BTS) 1104 and a Base Station Controller (BSC) 1106. The MS 1102 is physical equipment or Mobile Equipment (ME), such as a mobile phone or a laptop computer (e.g., device 12) that is used by mobile subscribers, with a Subscriber identity Module (SIM). The SIM includes an International Mobile Subscriber Identity (IMSI), which is a unique identifier of a subscriber. The BTS 1104 is physical equipment, such as a radio tower, that enables a radio interface to communicate with the MS. Each BTS may serve more than one MS. The BSC 1106 manages radio resources, including the BTS. The BSC may be connected to several BTSs. The BSC and BTS components, in combination, are generally referred to as a base station (BSS) or radio access network (RAN) 1103.

The GSM core network 1101 also includes a Mobile Switching Center (MSC) 1108, a Gateway Mobile Switching Center (GMSC) 1110, a Home Location Register (HLR) 1112, Visitor Location Register (VLR) 1114, an Authentication Center (AuC) 1118, and an Equipment Identity Register (EIR) 1116. The MSC 1108 performs a switching function for the network. The MSC also performs other functions, such as registration, authentication, location updating, handovers, and call routing. The GMSC 1110 provides a gateway between the GSM network and other networks, such as an Integrated Services Digital Network (ISDN) or Public Switched Telephone Networks (PSTNs) 1120. Thus, the GMSC 1110 provides interworking functionality with external networks.

The HLR 1112 is a database that contains administrative information regarding each subscriber registered in a corresponding GSM network. The HLR 1112 also contains the current location of each MS. The VLR 1114 is a database that contains selected administrative information from the HLR 1112. The VLR contains information necessary for call control and provision of subscribed services for each MS currently located in a geographical area controlled by the VLR. The HLR 1112 and the VLR 1114, together with the MSC 1108, provide the call routing and roaming capabilities of GSM. The AuC 1116 provides the parameters needed for authentication and encryption functions. Such parameters allow verification of a subscriber's identity. The EIR 1118 stores security-sensitive information about the mobile equipment.

A Short Message Service Center (SMSC) 1109 allows one-to-one Short Message Service (SMS) messages to be sent to/from the MS 1102. A Push Proxy Gateway (PPG) 1111 is used to “push” (i.e., send without a synchronous request) content to the MS 1102. The PPG 1111 acts as a proxy between wired and wireless networks to facilitate pushing of data to the MS 1102. A Short Message Peer to Peer (SMPP) protocol router 1113 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1102 sends a location update including its current location information to the MSC/VLR, via the BTS 1104 and the BSC 1106. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1130 is logically implemented on the GSM core network architecture by introducing two packet-switching network nodes, a serving GPRS support node (SGSN) 1132, a cell broadcast and a Gateway GPRS support node (GGSN) 1134. The SGSN 1132 is at the same hierarchical level as the MSC 1108 in the GSM network. The SGSN controls the connection between the GPRS network and the MS 1102. The SGSN also keeps track of individual MS's locations and security functions and access controls.

A Cell Broadcast Center (CBC) 1133 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1134 provides a gateway between the GPRS network and a public packet network (PDN) or other IP networks 1136. That is, the GGSN provides interworking functionality with external networks, and sets up a logical link to the MS through the SGSN. When packet-switched data leaves the GPRS network, it is transferred to an external TCP-IP network 1136, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 630 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel In a NOM3 network, a MS can monitor pages for a circuit switched network while received data and vise versa.

The IP multimedia network 638 was introduced with 3GPP Release 5, and includes an IP multimedia subsystem (IMS) 640 to provide rich multimedia services to end users. A representative set of the network entities within the IMS 640 are a call/session control function (CSCF), a media gateway control function (MGCF) 646, a media gateway (MGW) 648, and a master subscriber database, called a home subscriber server (HSS) 650. The HSS 650 may be common to the GSM network 601, the GPRS network 630 as well as the IP multimedia network 638.

The IP multimedia system 640 is built around the call/session control function, of which there are three types: an interrogating CSCF (I-CSCF) 643, a proxy CSCF (P-CSCF) 642, and a serving CSCF (S-CSCF) 644. The P-CSCF 642 is the MS's first point of contact with the IMS 640. The P-CSCF 642 forwards session initiation protocol (SIP) messages received from the MS to an SIP server in a home network (and vice versa) of the MS. The P-CSCF 642 may also modify an outgoing request according to a set of rules defined by the network operator (for example, address analysis and potential modification).

The I-CSCF 643, forms an entrance to a home network and hides the inner topology of the home network from other networks and provides flexibility for selecting an S-CSCF. The I-CSCF 643 may contact a subscriber location function (SLF) 645 to determine which HSS 650 to use for the particular subscriber, if multiple HSS's 650 are present. The S-CSCF 644 performs the session control services for the MS 602. This includes routing originating sessions to external networks and routing terminating sessions to visited networks. The S-CSCF 644 also decides whether an application server (AS) 652 is required to receive information on an incoming SIP session request to ensure appropriate service handling. This decision is based on information received from the HSS 650 (or other sources, such as an application server 652). The AS 652 also communicates to a location server 656 (e.g., a Gateway Mobile Location Center (GMLC)) that provides a position (e.g., latitude/longitude coordinates) of the MS 602.

The HSS 650 contains a subscriber profile and keeps track of which core network node is currently handling the subscriber. It also supports subscriber authentication and authorization functions (AAA). In networks with more than one HSS 650, a subscriber location function provides information on the HSS 650 that contains the profile of a given subscriber.

The MGCF 646 provides interworking functionality between SIP session control signaling from the IMS 640 and ISUP/BICC call control signaling from the external GSTN networks (not shown). It also controls the media gateway (MGW) 648 that provides user-plane interworking functionality (e.g., converting between AMR- and PCM-coded voice). The MGW 648 also communicates with other IP multimedia networks 654.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

While devices configured to provide an advertisement, methods of providing an advertisement, and network entities comprising software that is configured to provide an advertisement have been described in connection with the various embodiments of the various figures, it is to be understood that other similar embodiments can be used or modifications and additions can be made to the described embodiments for performing the same functions without deviating therefrom. For example, one skilled in the art will recognize that a device configured having a user interface configured to provide an advertisement via the device as described herein may apply to any environment, whether wired or wireless, and may be applied to any number of such devices connected via a communications network and interacting across the network. Therefore, a device configured to provide an advertisement (as well as methods for providing an advertisement and network entities comprising software that is configured to provide an advertisement) should not be limited to any single embodiment, but rather should be construed in breadth and scope in accordance with the appended claims.

What is claimed:

1. A communications device comprising:
a user interface portion configured to provide an advertisement,
wherein provision of said advertisement is correlated to an occurrence of an event associated with a use of said device,
the event comprising at least one of receipt by said device of an incoming call, initiation by said device of an outgoing call from said device, receipt by said device of a text based message, composition by a user of said device of an outgoing text message, or transmission by said device of an outgoing text message,
wherein said advertisement is supplied by an entity other than any of a sender of said incoming call, a recipient of said outgoing call from said device, a sender of said text based message, or a recipient of said outgoing text message.

2. The device according to claim 1 wherein the communications device is a mobile telephone.

3. The device according to claim 1 wherein the advertisement is provided acoustically, mechanically, visually, or olfactorily.

4. The device according to claim 1 wherein the advertisement comprises at least one of a customized text font, a ringtone, a viewscreen background, a background for a text based message, a weblink, or an advertising icon.

5. The device according to claim 1 wherein said user interface portion is further configured to accept a user input regarding said advertisement, substantive user input, or both.

6. The device according to claim 5 wherein said user input comprises a user response to said advertisement.

7. The device according to claim 5 wherein said user input comprises user preference information.

8. The device according to claim 5 further comprising:
a processing portion configured to create and optionally update a user profile that is based on said user input; and,
a memory portion configured to store said user profile and optionally receive updates of said user profile from said processing portion.

9. The device according to claim 8 wherein said user interface portion is configured to provide a second advertisement that is related to said user profile.

10. The device according to claim 5 wherein said user interface portion is further configured to provide a reward to said user in response to said user input.

11. A method comprising providing an advertisement through a user interface portion of a communications device,
wherein the provision of said advertisement is correlated to the occurrence of an event associated with a use of said device;
wherein the event comprises at least one of the receipt by said device of an incoming call, the initiation by said device of an outgoing call from said device, the receipt by said device of a text based message, the composition by a user of said device of an outgoing text message, or the transmission by said device of an outgoing text message; and,
wherein said advertisement is supplied by an entity other than any of a sender of said incoming call, a recipient of said outgoing call from said device, a sender of said text based message, or a recipient of said outgoing text message.

12. The method according to claim 11 wherein the advertisement is provided acoustically, mechanically, visually, or olfactorily.

13. The method according to claim 11 wherein the advertisement comprises at least one of a customized text font, a ringtone, a viewscreen background, a background for a text based message, a weblink, or an advertising icon.

14. The method according to claim 11 further comprising accepting a user input regarding said advertisement, substantive user input, or both.

15. The method according to claim 14 wherein said user input comprises a user response to said advertisement.

16. The method according to claim 14 wherein said user input comprises user preference information.

17. The method according to claim 14 further comprising creating, storing, and optionally updating a user profile that is based on said user input.

18. The method according to claim 17 further comprising providing a second advertisement that is related to said user profile.

19. The method according to claim 14 further comprising providing a reward to said user in response to said user input.

20. A network entity comprising software that is configured to provide an advertisement through a user interface portion of a communications device in communication with said network entity,
wherein the provision of said advertisement is correlated to the occurrence of an event associated with a use of said device;
wherein the event comprises at least one of the receipt by said device of an incoming call, the initiation by said device of an outgoing call from said device, the receipt by said device of a text based message, the composition by a user of said device of an outgoing text message, or the transmission by said device of an outgoing text message; and,
wherein said advertisement is supplied by an entity other than any of a sender of said incoming call, a recipient of said outgoing call from said device, a sender of said text based message, or a recipient of said outgoing text message.

21. The network entity according to claim 20 comprising a single component of a network.

22. The network entity according to claim 20 wherein said network entity comprises two or more components of a network.

23. The network entity according to claim 20 wherein said communications device is a mobile telephone.

24. The network entity according to claim 20 wherein said software is configured to provide a second advertisement through said user interface portion of said device, wherein said second advertisement is related to a user profile that is stored in said device.

25. The network entity according to claim 20 wherein said software is configured to provide a reward through said user interface portion of said device in response to a user input to said user interface portion regarding said advertisement.

26. The network entity according to claim 20 wherein the advertisement is provided visually, acoustically, mechanically, or olfactorily.

27. The network entity according to claim 20 wherein the advertisement comprises at least one of a customized text font, a ringtone, a viewscreen background, a background for a text based message, a weblink, or an advertising icon.

28. The network entity according to claim 20 wherein said software is configured to process or store, or both process and store substantive user input received from said device.
